(19) United States
(12) Patent Application Publication
(10) Pub. No.: US 2019/0147416 A1
(43) Pub. Date: May 16, 2019

(54) SYSTEM AND METHOD FOR FACILITATING MOBILE PAYMENTS VIA MOBILE MESSAGING

(71) Applicant: MESSAGE 4U PTY LIMITED, Melbourne (AU)

(72) Inventors: Grant RULE, Melbourne (AU); Matt MULLIGAN, Melbourne (AU)

(21) Appl. No.: 16/190,624

(22) Filed: Nov. 14, 2018

(30) Foreign Application Priority Data
Nov. 14, 2017 (AU) 2017904613

(51) Int. Cl. G06Q 20/08; G06Q 20/32

(52) U.S. Cl. CPC G06Q 20/0855; G06Q 20/3255; G06Q 20/3223

(57) ABSTRACT

A mobile payment processing system comprises a data store storing: payment gateway credentials for each of a plurality of vendors, the payment gateway credentials being used for accessing a selected payment gateway; and consumer payment credentials for consumers that have transacted with any one of the plurality of vendors, with the credentials being stored in association with a unique consumer identifier. The system further comprises a third-party payment processing facilitator which implements a backend operable to access the data store, as well as being operable to communicate with each of the plurality of vendors and at least one payment gateway. The third party payment processing facilitator is further configured to: receive a transaction request from one of the vendors via the backend, the transaction request comprising: a unique consumer identifier for a consumer; and payment information for a corresponding transaction; process the transaction request to determine the unique consumer identifier and evaluate the data store to establish if there are associated consumer payment credentials stored therein; responsive to establishing that there are associated consumer payment credentials, send a message to a mobile device operated by the consumer seeking the consumer's confirmation to process the transaction; and responsive to receiving the consumer's confirmation, communicate the consumer's payment credentials together with the payment gateway credentials for the vendor to the corresponding payment gateway for completing the transaction.

The invention is described in the following statement:

### FIELD OF INVENTION

The present invention relates generally to a system and method for facilitating payments via a mobile messaging protocol, such as short message service (SMS), rich communication service (RCS), over the top (OTT) message service or the like.

### BACKGROUND OF INVENTION

Consumers increasingly access online services using smartphones, however are reluctant to enter payment credentials on mobile devices as provided systems are not optimised for mobile use. Further, merchants have been slow to offer mobile payment systems because they are concerned about the cost and complexity of replacing their current payment systems.

It would be advantageous if there was provided a system and method that offered a convenient way for consumers to make payments to merchants using their smartphone without requiring any significant upgrade to the merchants existing systems. It would also be advantageous if the system and method obviated the need to re-enter payment credentials each time they wanted to make a payment to a merchant they had not previously interacted with.

### SUMMARY OF INVENTION

In accordance with a first aspect there is provided a mobile payment processing system, comprising: a data store storing: payment gateway details for each of a plurality of vendors, the payment gateway details being utilisable for accessing a selected payment gateway; and consumer payment details for consumers that have transacted with any one of the plurality of vendors, the consumer payment details being stored in association with a unique consumer identifier; a third-party payment processing facilitator implementing a backend operable to access the data store and for communicating with each of the plurality of vendors and at least one payment gateway, the third-party payment processing facilitator configured to: receive a transaction request from one of the vendors via the backend, the transaction request comprising: a unique consumer identifier for a consumer; and payment information for a corresponding transaction; process the transaction request to determine the unique consumer identifier and evaluate the data store to establish if there are associated consumer payment credentials stored therein; responsive to establishing that there are associated consumer payment credentials, send a message via a messaging service to a mobile device operated by the consumer seeking the consumer's confirmation to process the transaction; responsive to receiving the consumer's confirmation, communicate the consumer's payment credentials together with the payment gateway credentials for the vendor to the corresponding payment gateway for completing the transaction.

In accordance with a second aspect there is provided a mobile payment processing method, comprising: implementing a data store storing: payment gateway details for each of a plurality of vendors, the payment gateway credentials being used for accessing a selected payment gateway; and consumer payment credentials for consumers that have transacted with any one of the plurality of vendors, the credentials being stored in association with a unique consumer identifier; receiving a transaction request from one of the vendors, the transaction request comprising: a unique consumer identifier for a consumer; and payment information for a corresponding transaction; processing the transaction request to determine the unique consumer identifier and evaluating the data store to establish if there are associated consumer payment details stored therein; responsive to establishing that there are associated consumer payment details, sending a message to a mobile device operated by the consumer seeking the consumer's confirmation to process the transaction; and responsive to receiving the consumer's confirmation, communicating the consumer's payment details together with the payment gateway details for the vendor to the corresponding payment gateway for completing the transaction.

### BRIEF DESCRIPTION OF DRAWINGS

Embodiments of the present invention will now be described, by way of example only, with reference to the accompanying drawings, in which:

FIG. 1 is a schematic of a system, in accordance with an embodiment of the invention; and

FIG. 2 is a flow chart setting out steps for completing an SMS based payment transaction, in accordance with an embodiment.

### DETAILED DESCRIPTION

As will be outlined in detail in subsequent paragraphs, embodiments of the present invention combine SMS, RTC and/or OTT messaging with a common wallet facility that allows consumers to store a single set of payment details/credentials for use with multiple vendors, with whom they may or may not have existing relationships. The system and method may advantageously obviate the need for consumers to provide transaction details each time they transact with a new vendor using a novel mobile messaging procedure as outlined in the following description.

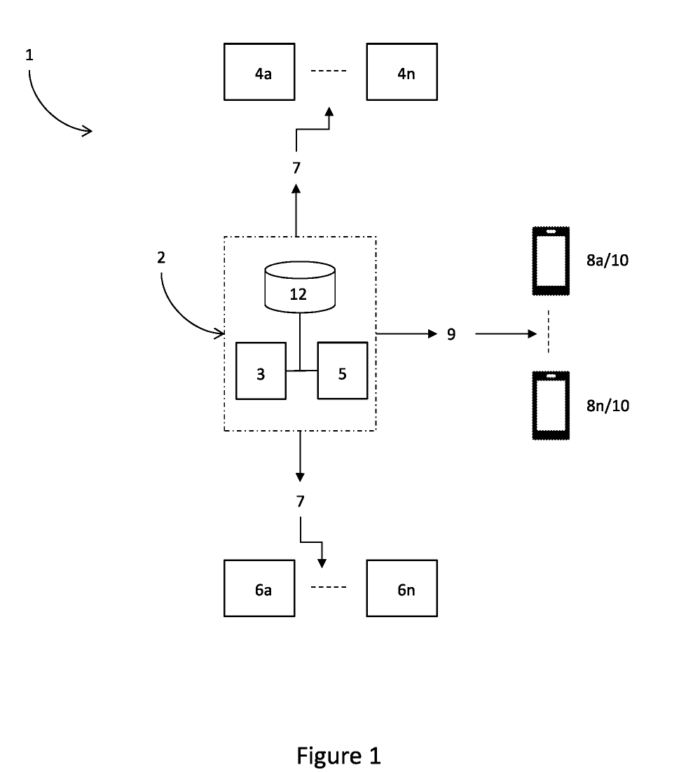

FIG. 1 depicts an example system architecture in which embodiments of the present invention can be implemented. As illustrated, the system 1 includes a third-party payment processing facilitator 2 (hereafter TPPF), one or more payment gateways 4a to 4n, a plurality of vendors 6a to 6n and a plurality of consumer 8a to 8n. Each consumer operates a respective mobile device 10.

In more detail, the TPPF 2 implements a backend comprising an API gateway 3 for communicating with the payment gateways 4a to 4n and vendors 6a to 6n via a network 7, such as the Internet. Communications may be made using protocols such as REST, SOAP and HTTP APIs, as well as secure file transfers such as SFTP, FTPS and SCP. The gateway 3 is additionally configured to send and receive messages to/from the consumer mobile devices 10 via mobile network 9. Finally, the TPPF 2 implements a web server 5 for communicating with the mobile devices 10 for receiving consumer payment credentials, via a browser or mobile application resident thereon. According to the illustrated embodiment, the messages take the form of SMS messages, although it will be understood that the messages may be delivered using RTC, OTT or other suitable messaging protocol/service.

The backend further comprises a data store 12 for storing payment credentials for each of the consumers. The consumer payment credentials may comprise any form of credential that can be utilised by a payment gateway 4a to 4n for completing a transaction. For example, the credentials may comprise a tokenized debit or credit card number, as well as relevant credentials for direct debit or new payment platform (NPP) payments. The payment credentials are stored in association with a unique identifier for the consumer. According to the illustrated embodiment, the unique identifier comprises a MSISDN which persons skilled in the art will understand is a number uniquely identifying a subscription in a GSM or a UMTS mobile network. Alternatively, the unique identifier could be some other identifier (e.g. device UID) that can be used to look up the consumer's payment credentials (in which case the MSIDN would be additionally stored in the data store 12 in association with the unique identifier).

The common data store 12 additionally stores payment gateway credentials for each of the vendors 6a to 6n. The payment gateway credentials are stored in association with a unique vendor identifier and include the necessary credentials required by a selected one of the payment gateways 4a to 4n for transferring funds received as part of a transaction to a nominated vendor account.

The data store 12 may be implemented using any suitable relational or non-relational database application program, such as, e.g., Oracle, Sybase and the like. According to the embodiment described herein, the data store 12 takes the form of a relational database. It will be understood that the aforementioned data stores can take any suitable digital form, from a standard SQL database to a distributed cloud store to a blockchain ledger.

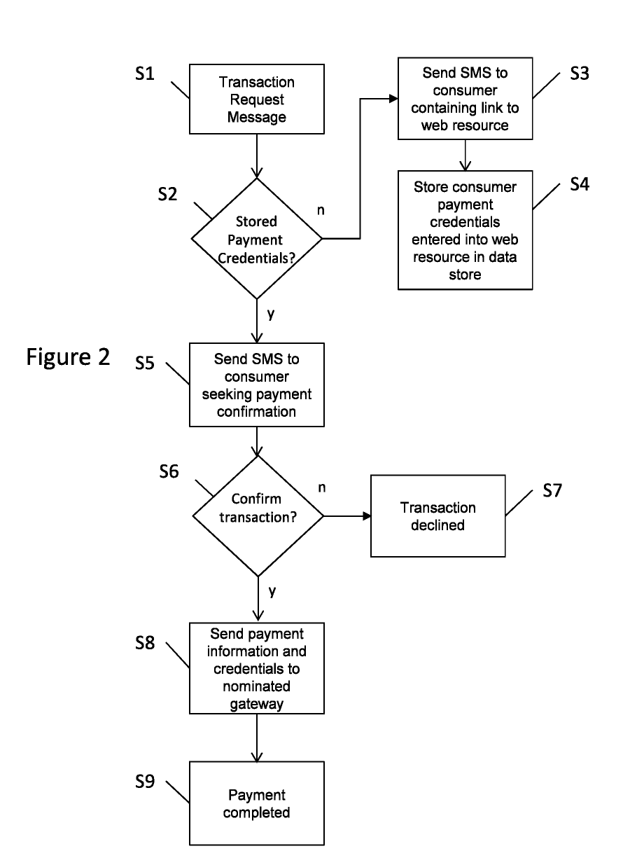

In more detail, and with additional reference to the flow chart of FIG. 2, an embodiment of the SMS based payment processing method involves the TPPF 2 receiving a transaction request message from one of the vendors 6a to 6n (step S1). The transaction request message may be generated by the vendor as an isolated action (e.g. as a result of a consumer purchasing an item on a merchant website, etc.) or periodically (e.g. at the end of a billing cycle for a service that is provided to the consumer). Isolated actions might include, for example, processing an online shopping cart, or interacting with a POS application. Periodic transactions are likely to be generated by service management software, such as for processing a monthly bill.

The transaction request message is received via the API gateway 3. As previously stated, the request includes a unique identifier for the consumer, a vendor identifier and the relevant transaction details (e.g. amount, payment date, etc.). The request may also include the name of the consumer and a charge name (or similar). According to the illustrated embodiment, the transaction request message takes the form of a JSON (JavaScript Object Notation) document that is posted to a REST endpoint for the API gateway 3 (or alternatively via SFTP/FTPS if that protocol is utilised by the system).

At step S2, the TPPF 2 processes the request to retrieve the information contained therein. It then carries out a look up procedure to determine if the data store 12 contains payment credentials for the consumer, utilising the unique identifier. If there are no stored payment credentials, at step S3, the TPPF 2 generates and sends a credential request SMS message to the consumer 8. The credential request SMS message includes a URL to a payment credential registration page stored on the web server 5. Once the consumer 8 has entered the relevant credentials, they are subsequently stored in the data store in association with the consumer's unique identifier (step S4).

Following step S4, or in response to making a positive determination at step S2, the process proceeds to step S5 comprising generating and sending a transaction request SMS message to the consumer 8 including a request for payment for a particular transaction (i.e. either initiated by the consumer or vendor, as previously described). The transaction request SMS message may include details about the transaction (such as a transaction identifier vendor name, purchase amount, etc.). The SMS asks the consumer 8 to confirm or decline the transaction by responding with a predefined response consisting of a letter, word or phrase. By way of example, a predefined confirmation response may include “Yes”, “Y”, “Pay”, “P”, or the like. A decline response may include “No”, “Decline”, etc.

At step S6 the TPPF 2 monitors for an SMS response from the mobile device 10 (i.e. received via the gateway 3). If an SMS decline response is received, or an SMS response is not received within a predefined timeframe, the TPPF 2 declines the transaction and sends an electronic communication to the relevant vendor 6a to 6n notifying them of the same (step S7).

Alternatively, if at step S6, an SMS is received including the predefined confirmation response, the TPPF 2 generates a payment gateway message which includes the payment amount, the relevant consumer payment credentials and the relevant vendor gateway credentials. The gateway message is then communicated to the vendor's nominated payment gateway 4a to 4n for processing (step S8).

The payment gateway 4a to 4n subsequently processes the payment and returns a confirmation to the TPPF 2. At step S9, the TPPF 2 communicates the confirmation to the vendor 6a to 6n for actioning (e.g. dispatching a product, updating a bill as having been paid, etc.) and notifies the consumer 8 that the payment has been completed.

It will be understood that the above described methodology could be implemented by way of OTT or RCS messaging as opposed to SMS based messaging.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

The preceding description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

In addition, the foregoing describes only some embodiments of the inventions, and alterations, modifications, additions and/or changes can be made thereto without departing from the scope and spirit of the disclosed embodiments, the embodiments being illustrative and not restrictive.

Furthermore, whilst the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of this disclosure. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. A mobile payment processing system, comprising:
a data store storing:
(a) payment gateway details for each of a plurality of vendors, the payment gateway details utilisable for accessing a selected payment gateway; and
(b) consumer payment details for consumers that have transacted with any one of the plurality of vendors, the consumer payment details being stored in association with a unique consumer identifier;
a third-party payment processing facilitator implementing a backend operable to access the data store and for communicating with each of the plurality of vendors and at least one payment gateway, the third-party payment processing facilitator configured to:
receive a transaction request from one of the vendors via the backend, the transaction request comprising: a unique consumer identifier for a consumer; and payment information for a corresponding transaction;
process the transaction request to determine the unique consumer identifier and evaluate the data store to establish if there are associated consumer payment details stored therein;
responsive to establishing that there are associated consumer payment details, send a message to a mobile device operated by the consumer seeking the consumer's confirmation to process the transaction; and
responsive to receiving the consumer's confirmation, communicate the consumer's payment details together with the payment gateway details for the vendor to the corresponding payment gateway for completing the transaction.

2. A mobile payment processing system in accordance with claim 1, wherein in response to establishing that there are no associated consumer payment details stored in the data store, sending a message to a mobile device operated by the consumer, the message including a link to a web resource which prompts the consumer to enter their consumer payment details for subsequent storing in the data store in association with a unique consumer identifier, such that once the consumer payment details have been entered they can be used to complete a transaction for any one of the plurality of vendors.

3. A mobile payment processing system in accordance with claim 1, wherein the consumer's confirmation is received via a returned message and comprises one or more predefined text, audio or image-based responses.

4. A mobile payment processing system in accordance with claim 1, wherein the consumer payment details comprise at least one of: tokenized debit card information; tokenized credit card information; and relevant credentials for direct debit or new payment platform (NPP) payments.

5. A mobile payment processing system in accordance with claim 1, wherein a mobile phone number for the consumer is stored in the data store in association with the unique identifier and wherein the mobile phone number is used for communicating with the mobile device.

6. A mobile payment processing system in accordance with claim 1, further comprising receiving a response from the gateway confirming that the transaction has been completed.

7. A mobile payment processing system in accordance with claim 6, responsive to receiving confirmation from the gateway, the third-party further configured to send a further message to the consumer notifying the consumer that the transaction has been completed.

8. A mobile payment processing system in accordance with claim 1, wherein the transaction request is generated by the vendor as part of a transaction completed on a website implemented by the vendor.

9. A mobile payment processing system in accordance with claim 1, wherein the transaction request is generated periodically by the vendor in relation to a service they provide to the consumer.

10. A mobile payment processing system in accordance with claim 1, wherein the messages sent between the mobile device and third-party payment processing facilitator are at least one of: short message service (SMS) messages, rich communication services (RCS) messages and over the top (OTT) messages.

11. A mobile payment processing method, comprising:
implementing a data store storing:
(a) payment gateway details for each of a plurality of vendors, the payment gateway details being used for accessing a selected payment gateway; and
(b) consumer payment details for consumers that have transacted with any one of the plurality of vendors, the consumer payment details being stored in association with a unique consumer identifier;
receiving a transaction request from one of the vendors, the transaction request comprising: a unique consumer identifier for a consumer; and payment information for a corresponding transaction;
processing the transaction request to determine the unique consumer identifier and evaluating the data store to establish if there are associated consumer payment details stored therein;
responsive to establishing that there are associated consumer payment details, sending a message to a mobile device operated by the consumer seeking the consumer's confirmation to process the transaction; and
responsive to receiving the consumer's confirmation, communicating the consumer's payment details together with the payment gateway credentials for the vendor to the corresponding payment gateway for completing the transaction.

12. A mobile payment processing method in accordance with claim 11, wherein in response to establishing that there are no associated consumer payment details stored in the data store, the method further comprises sending a message to a mobile device operated by the consumer, the message including a link to a web resource which prompts the consumer to enter their consumer payment details for subsequent storing in the data store in association with a unique consumer identifier, such that once the consumer payment details have been entered they can be used to complete a transaction for any one of the plurality of vendors.

13. A mobile payment processing method in accordance with claim 11, wherein the consumer's confirmation is received via a returned message and comprises one or more predefined message-based responses.

14. A mobile payment processing method in accordance with claim 11, wherein the consumer payment details comprise at least one of: tokenized debit card information; tokenized credit card information; and relevant credentials for direct debit or new payment platform (NPP) payments.

15. A mobile payment processing method in accordance with claim 11, wherein a mobile phone number for the consumer is stored in the data store in association with the unique identifier and wherein the mobile phone number is used for communicating with the mobile device.

16. A mobile payment processing method in accordance with claim 11, further comprising receiving a response from the gateway confirming that the transaction has been completed.

17. A mobile payment processing method in accordance with claim 11, responsive to receiving confirmation from the gateway, sending a further message to the consumer notifying the consumer that the transaction has been completed.

18. A mobile payment processing method in accordance with claim 11, wherein the transaction request is generated by the vendor as part of a transaction completed on a website implemented by the vendor.

19. A mobile payment processing method in accordance with claim 11, wherein the transaction request is generated periodically by the vendor in relation to a service they provide to the consumer.

20. A mobile payment processing system in accordance with claims 11, wherein the messages sent between the mobile device and third-party payment processing facilitator are sent using at least one of the following message protocols: short message service (SMS); rich communication services (RCS) messages; and over the top (OTT) messages.
